(19) United States
(12) Patent Application Publication
(10) Pub. No.: US 2015/0205244 A1
(43) Pub. Date: Jul. 23, 2015

(54) IMAGE FORMING APPARATUS, AND MEDIUM TRANSPORTING DEVICE

(71) Applicant: FUJI XEROX CO., LTD., Tokyo (JP)

(72) Inventor: Megumi HARADA, Kanagawa (JP)

(21) Appl. No.: 14/534,599

(22) Filed: Nov. 6, 2014

(30) Foreign Application Priority Data
Jan. 17, 2014 (JP) 2014-006785

(51) Int. Cl. G03G 15/00

(52) U.S. Cl. CPC G03G 15/6552

(57) ABSTRACT

Provided is an image forming apparatus including an image forming device that forms an image on a recording medium, a stacking table on which the recording medium having the image formed thereon by the image forming device is stacked, and a medium transporting device that transports the recording medium to the stacking table from the image forming device, wherein the medium transporting device includes a pair of rotating members that feed the recording medium to the stacking table, a moving unit that allows the pair of rotating members to reciprocate in a direction along a rotating shaft of the pair of rotating members, and a pressing and separating unit that allows the pair of rotating members to be pressed against each other in a forward path during the reciprocation by the moving unit and to be separated from each other in a return path.

### CROSS-REFERENCE TO RELATED APPLICATIONS

This application is based on and claims priority under 35 USC 119 from Japanese Patent Application No. 2014-006785 filed Jan. 17, 2014.

### BACKGROUND

(i) Technical Field

The present invention relates to an image forming apparatus, and a medium transporting device.

(ii) Related Art

Hitherto, an image forming apparatus which forms an image on a recording medium such as a sheet or an OHP sheet, and a medium transporting device which is embedded in the image forming apparatus and transports the recording medium is known.

### SUMMARY

According to an aspect of the invention, there is provided an image forming apparatus including:

an image forming device that forms an image on a recording medium;

a stacking table on which the recording medium having the image formed thereon by the image forming device is stacked; and

a medium transporting device that transports the recording medium to the stacking table from the image forming device,

wherein the medium transporting device includes:

a pair of rotating members that feed the recording medium to the stacking table by nipping the recording medium therebetween and rotating;

a moving unit that allows the pair of rotating members to reciprocate in a direction along a rotating shaft of the pair of rotating members; and

a pressing and separating unit that allows the pair of rotating members to be pressed against each other in a forward path during the reciprocation by the moving unit and to be separated from each other in a return path during the reciprocation by the moving unit.

### BRIEF DESCRIPTION OF THE DRAWINGS

Exemplary embodiments of the present invention will be described in detail based on the following figures, wherein:

FIG. 1 is a schematic configuration diagram of a multifunction machine corresponding to an exemplary embodiment of an image forming apparatus of the invention;

FIGS. 2A and 2B are diagrams illustrating a sorting mechanism in a comparative example;

FIGS. 3A and 3B are timing charts of sorting in the comparative example;

FIGS. 4A and 4B are diagrams illustrating a sorting mechanism in this exemplary embodiment and a first stage of the order of discharging sheets to a second discharge position;

FIGS. 5A and 5B are diagrams illustrating a second stage of the order of discharging sheets to the second discharge position;

FIGS. 6A and 6B are diagrams illustrating a third stage of the order of discharging sheets to the second discharge position;

FIGS. 7A and 7B are diagrams illustrating a fourth stage of the order of discharging sheets to the second discharge position;

FIGS. 8A and 8B are diagrams illustrating a fifth stage of the order of discharging sheets to the second discharge position;

FIGS. 9A and 9B are diagrams illustrating a sixth stage of the order of discharging sheets to the second discharge position;

FIGS. 10A and 10B are diagrams illustrating a seventh stage of the order of discharging sheets to the second discharge position; and

FIGS. 11A to 11D are timing charts illustrating the operational timing of each unit in the order illustrated in FIGS. 4A to 10B.

### DETAILED DESCRIPTION

Hereinafter, an exemplary embodiment of the invention will be described with reference to the drawings.

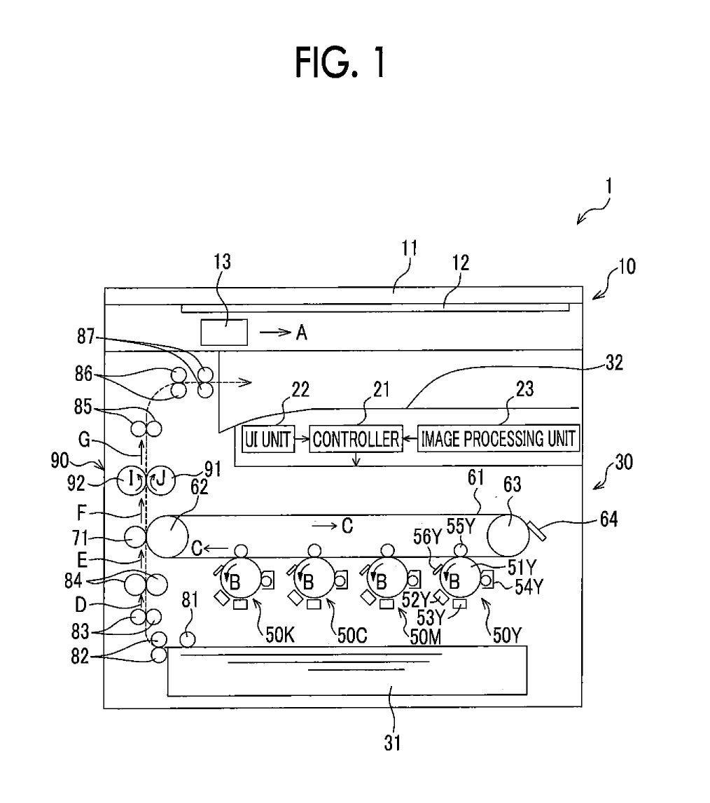

FIG. 1 is a schematic configuration diagram of a multifunction machine corresponding to an exemplary embodiment of an image forming apparatus of the invention. In the multifunction machine, an exemplary embodiment of a medium transporting device of the invention is embedded.

In the upper portion of a multifunction machine 1, an image reading unit 10 which reads an image from an original document is provided. The image reading unit 10 includes a cover 11 which is opened and closed around a hinge as a rotating shaft, a transparent platen glass 12 which is disposed immediately below the cover 11, an image reading sensor 13 which is disposed further below the platen glass 12. During image reading by the image reading unit 10, the cover 11 is opened and the original document is set on the platen glass 12 to face downward. In addition, when the cover 11 is closed and a start button is pressed, the image of the original document is read to generate image data. The image reading sensor 13 extends in the depth direction (a direction perpendicular to FIG. 1) of the multifunction machine 1 and sequentially reads the image of the original document while moving in the arrow A direction to generate image data.

In the multifunction machine 1, a controller 21 which controls the operations of the entirety of the multifunction machine 1 is provided, and an image processing unit 23 is also provided which receives image data from an external device such as a. personal computer (PC), an internal telephone communication device (not illustrated), or the above-mentioned image reading unit 10 and performs image processing on the image data. In addition, in the multifunction machine 1, a number of operation buttons including the above-mentioned start button and a display screen are provided, and a user interface (UI) unit 22 is also provided which receives operational inputs from a user and displays various types of information for the user.

Furthermore, in the multifunction machine 1, an image forming section 30 is provided which forms an image according to image data for each color. The image formation performed in the image forming section 30 is performed based on the image data obtained by the reading by the image reading unit 10, or the image data received from the external device such as a PC or the internal telephone communication device (not illustrated) in the multifunction machine 1. That is, the multifunction machine 1 has functions of a copying machine, a printer, and a facsimile.

The image forming section 30 includes four image forming engines 50Y, 50M, 50C, and 50K that are horizontally arranged. The image forming engines 50Y, 50M, 50C, and 50K are engines that respectively form toner images using toners of colors of yellow (Y), magenta (M), cyan (C), and black (K). The image forming engines 50Y, 50M, 50C, and 50K have the same configuration except for the difference in toner color in use. Hereinafter, in a case where the colors do not need to be distinguished, the characters Y, M, C, and K representing the colors are omitted and only the reference numerals are used in the description.

Each of the image forming engines 50 includes a photosensitive drum 51 which rotates in the arrow B direction. In addition, in each of the image forming engines 50, a charging unit 52, an exposure unit 53, a developing unit 54, a transfer unit 55, and a cleaner 56 are provided in the periphery of the photosensitive drum 51.

The charging unit 52 uniformly charges the surface of the photosensitive drum 51, and the exposure unit 53 irradiates the photosensitive drum 51 with exposure light modulated according to the image data, thereby forming an electrostatic latent image on the surface of the photosensitive drum 51.

In the developing unit 54, color (Y, M, C, or K) toner corresponding to the image forming engine 50Y, 50M, 50C, or 50K is accommodated, and the electrostatic latent image on the photosensitive drum 51 is developed by the accommodated toner, thereby forming a toner image on the photosensitive drum 51.

On the four image forming engines 50Y, 50M, 50C, and 50K that are horizontally arranged, an endless intermediate image transfer belt 61 which is wound around rollers 62 and 63 is disposed, and is circulated in the arrow C direction on a circulation path along the four image forming engines 50Y, 50M, 50C, and 50K.

The toner images formed on the photosensitive drums 51 are transferred to be sequentially overlapped on the intermediate image transfer belt 61 by the actions of the respective transfer units 55 of the image forming engines 50.

The cleaner 56 removes unnecessary toner that remains on the photosensitive drum 51 after the transfer from the photosensitive drum 51 to clean the photosensitive drum 51.

The toner images that are transferred to be sequentially overlapped on the intermediate image transfer belt 61 are transported by the intermediate image transfer belt 61 to be transferred onto a sheet by the action of a secondary image transfer unit 71. Unnecessary toner that remains on the intermediate image transfer belt 61 after the transfer onto the sheet is removed from the intermediate image transfer belt 61 by a cleaner 64.

Below the image forming section 30, a sheet tray 31 which may be drawn out is provided. In the sheet tray 31, sheets before being subjected to the image formation are stacked and accommodated as recording media used for the image formation.

The sheets accommodated in the sheet tray 31 are taken out by a pickup roller 81, and when several sheets are taken out while overlapping, the sheets are reliably separated from each other one by one by separating rollers 82 so that a single sheet is transported to timing adjusting rollers 84 in the arrow D direction by transporting rollers 83.

In addition, in synchronization with a timing at which the toner images transferred onto the intermediate image transfer belt 61 are transported to the position of the secondary image transfer unit 71, a timing is adjusted to allow the sheet to be transported to the position, and the sheet is fed in the arrow E direction by the timing adjusting rollers 84. In addition, the toner images on the intermediate image transfer belt 61 are transferred onto the sheet by the action of the secondary image transfer unit 71.

The sheet on which the toner images are transferred is further transported in the arrow F direction and passes through a fixing unit 90. In the fixing unit 90, a press roller 92 which rotates in the arrow I direction and a heating roller 91 which rotates in the arrow J direction are provided. The sheet transported to the fixing unit 90 is nipped between the press roller 92 and the heating roller 91 to be pressed and heated such that the toner images on the sheet are fixed onto the sheet.

The sheet which passes through the fixing unit 90 is further transported in the arrow G direction by transporting rollers 85, and is discharged onto a sheet discharge tray 32 provided above the image forming section 30 by sorting rollers 86 and discharge rollers 87.

In the image forming section 30 in the multifunction machine 1 illustrated in FIG. 1, a part on the lower side from the fixing unit 90 corresponds to an example of an image forming device described in the invention, a part on the upper side from the fixing unit 90 corresponds to an example of a medium transporting device described in the invention, and the sheet discharge tray 32 corresponds to an example of a stacking table described in the invention.

When sheets are discharged onto the sheet discharge tray 32, there may be cases where the sheets are sorted by an instruction of the user via the operation of the UI unit 22 so as to be discharged. In the multifunction machine 1, as described below in detail, a function of shifting the discharge position of a sheet in the depth direction by moving the sheet nipped between the sorting rollers 86 in the depth direction (the direction perpendicular to FIG. 1) is provided. By this function, for example, sorting is performed in a form in which sheets are stacked on the sheet discharge tray 32 while the sheets are shifted in the depth direction one by one. In the sorting method implemented by moving the sorting rollers 86, transportation and sorting of the sheets are simultaneously processed, resulting in an increase in productivity. In addition, the sorted sheets are discharged on a common transport path to the sheet discharge tray 32, thereby achieving a reduction in space and a reduction in the size of the apparatus.

Here, the description of this exemplary embodiment is temporarily stopped and a comparative example will be described.

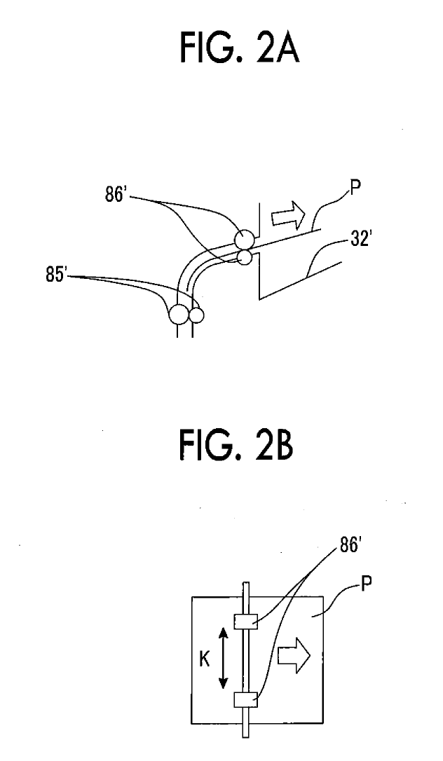

FIGS. 2A and 2B are diagrams illustrating a sorting mechanism in the comparative example.

FIG. 2A illustrates a side view of the mechanism, and FIG. 2B illustrates a plan view of the mechanism.

In the comparative example, transporting rollers 85′ which transports a sheet P to a sheet discharge tray 32′ are provided, and sorting rollers 86′ which shift the discharge position of the sheet in the depth direction (a direction perpendicular to FIG. 2A on the space, and a direction indicated by the arrow K in FIG. 2B) while transporting the sheet P are provided as a mechanism for sorting the sheet P. During the sorting in this comparative example, two discharge positions are used as the discharge position of the sheet P. The first discharge position is a discharge position when the sorting rollers 86′ do not move and the sheet P transported from the transporting rollers 85′ is advanced by the sorting rollers 86′ and is discharged onto the sheet discharge tray 32′. The second discharge position is a discharge position when the sheet P transported from the transporting rollers 85′ is received by the sorting rollers 86′ and the sorting rollers 86′ move their positions in the arrow K direction (here, as an example, an upward direction) while transporting the sheet P to the sheet discharge tray 32′. Therefore, the second discharge position is a position shifted from the first discharge position in the arrow K direction (here, as an example, the upward direction).

Using the two discharge position, for example, in a case where m bundles of sheets need to be printed while n sheets make one bundle, in order to perform sorting in units of bundles, first, n sheets P are stacked on the sheet discharge tray 32′ at the first discharge position. Next, n sheets P are stacked on the sheet discharge tray 32′ while being moved to the second discharge position by the sorting rollers 86′ sheet by sheet. Next, n sheets P are stacked on the sheet discharge tray 32′ at the first discharge position again. In this manner, bundles of sheets are alternately stacked between the two discharge positions.

During the sorting in the comparative example, a movement timing of the sorting rollers 86′ will further be described.

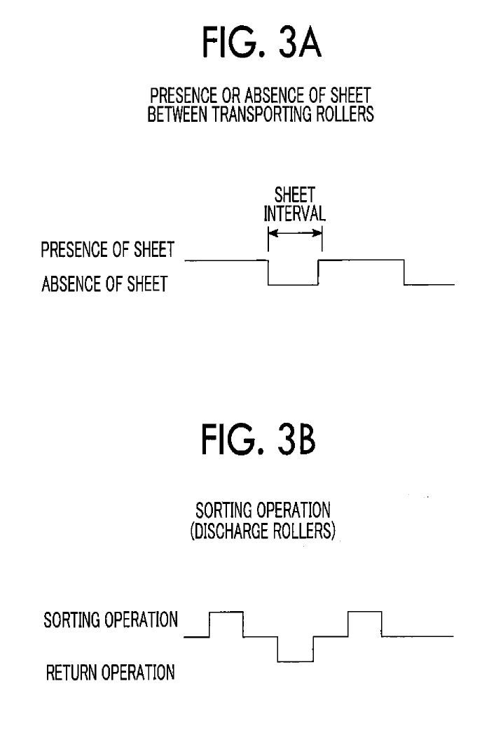

FIGS. 3A and 3B are timing charts of the sorting in the comparative example.

FIG. 3A illustrates timing in which the sheet passes through the transporting rollers 85′, and FIG. 3B illustrates the movement timing of the sorting rollers 86′. The vertical axis of the chart of FIG. 3A represents the presence or absence of the sheet between the transporting rollers 85′ which form a pair. In addition, the vertical axis of the chart of FIG. 3B represents the movement direction of the sorting rollers 86′, in which the sorting rollers 86′ are moved upward in the arrow K direction of FIG. 2B during a “sorting operation”, and the sorting rollers 86′ are moved downward in the arrow K direction of FIG. 2B during a “return operation”.

The sheet is nipped between the sorting rollers 86′ forming a pair during the “sorting operation” and the sheet is moved to the second discharge position. On the other hand, during the “return operation”, the sheet is not present between the sorting rollers 86′ forming the pair. Therefore, as a time interval (sheet interval) between the sheets that pass through the transporting rollers 85′, a longer time interval than a time needed for the “return operation” of the sorting rollers 86′ is needed.

Contrary to this limitation to the time interval, the multifunction machine 1 illustrated in FIG. 1 has an ability to continuously form images with substantially no intervals between sheets, as a production capacity on the upstream side (the lower side of FIG. 1) from the fixing unit 90. Therefore, in a case where the mechanism of the comparative example illustrated in FIGS. 2A and 2B is employed by the multifunction machine 1 illustrated in FIG. 1, productivity is degraded due to a time needed for the above-described “return operation”.

Here, returning to the description of this exemplary embodiment, the sorting of the sheets will be described.

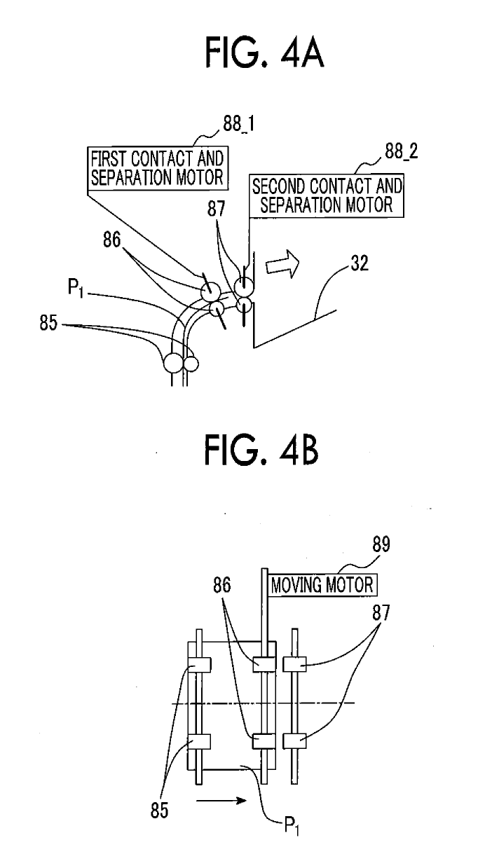

FIGS. 4A and 4B are diagrams illustrating a sorting mechanism in this exemplary embodiment.

FIG. 4A illustrates a side view of the mechanism, and FIG. 4B illustrates a plan view of the mechanism.

As described above, in this exemplary embodiment, the transporting rollers 85, the sorting rollers 86, and the discharge rollers 87 are provided. Any of the transporting rollers 85, the sorting rollers 86, and the discharge rollers 87 forms a pair, and as the sheet P1 is nipped between the rollers forming a pair and each roller is rotated, the sheet P1 is transported to the sheet discharge tray 32. The illustration of a driving system which drives each roll to rotate is omitted. The pair of sorting rollers 86 corresponds to an example of a pair of rotating members (a pair of first rotating members) described in the invention, and the pair of discharge rollers 87 corresponds to an example of a pair of second rotating members described in the invention.

As illustrated in FIG. 4B, a moving motor 89 is connected to the sorting rollers 86. The moving motor 89 moves the sorting rollers 86 in a direction along the rotating shaft of the sorting rollers 86 (that is, the vertical direction of FIG. 4B) according to the control by the controller 21 illustrated in FIG. 1. The moving motor 89 corresponds to an example of a moving unit described in the invention. In addition, as a specific mechanism that moves the sorting rollers 86 in the direction along the rotating shaft, a well-known arbitrary mechanism may be employed, and further detailed description thereof is omitted. However, a mechanism that does not interrupt the rotation of the sorting rollers 86 when the sorting rollers 86 are moved in the direction along the rotating shaft is used.

As illustrated in FIG. 4A, a first contact and separation motor 88_1 is connected to the sorting rollers 86, and a second contact and separation motor 88_2 is connected to the discharge rollers 87. The first contact and separation motor 88_1 and the second contact and separation motor 88_2 respectively move the sorting rollers 86 and the discharge rollers 87 in a direction in which the rollers forming a pair approach each other and become separated from each other (that is, in the vertical direction of FIG. 4A) according to the control by the controller 21 illustrated in FIG. 1. The first contact and separation motor 88_1 corresponds to an example of a pressing and separating unit (first pressing and separating unit) described in the invention, and the second contact and separation motor 88_2 corresponds to an example of a second pressing and separating unit described in the invention. As a specific mechanism that moves the rollers forming a pair in a direction in which the rollers approach each other and become separated from each other, a well-known arbitrary mechanism may also be employed, and further detailed description thereof is omitted. However, a mechanism that does not interrupt the rotation of the sorting rollers 86 and the like during the movement in the direction in which the rollers approach each other and become separated from each other is used.

The sorting order by the mechanism having the above-described structure will now be described. In addition, in order to avoid complex illustration, in the following drawings, the illustration of the moving motor 89, the first contact and separation motor 88_1, and the second contact and separation motor 88_2 is omitted, and the movement of only the sorting rollers 86 and the discharge rollers 87 is illustrated. Each motor is denoted by the reference numeral described in FIGS. 4A and 4B.

Even in the case of the sorting in this exemplary embodiment, similarly to the case of the sorting in the above-described comparative example, the first discharge position and the second discharge position are used. In addition, for ease of the following description, as illustrated in FIG. 4B, the position of the sorting rollers 86 aligned with the transporting rollers 85 and the discharge rollers 87 is called a home position, and the position of the sorting rollers 86 which is moved upward in FIG. 4B from the home position and corresponds to the second discharge position is called a shift position.

During the sorting in this exemplary embodiment, for example, in a case where m bundles of sheets need to be printed while n sheets make one bundle, in order to perform sorting in units of bundles, first, n sheets are stacked on the sheet discharge tray 32 at the first discharge position. Subsequent n sheets are stacked on the sheet discharge tray 32 while being moved to the second discharge position one by one. Subsequent n sheets are stacked on the sheet discharge tray 32 at the first discharge position. In this manner, bundles of sheets are alternately stacked between the two discharge positions.

In the case where sheets are discharged to the first discharge position, while the sorting rollers 86 are at the home position, the transporting rollers 85, the sorting rollers 86, and the discharge rollers 87 straightly transport the sheets so as to be stacked on the sheet discharge tray 32.

On the other hand, the case of discharging the sheets to the second discharge position will now be described in more detail with reference to the drawings.

As illustrated in FIGS. 4A and 4B, when a sheet P1 is transported by the transporting rollers 85, the sorting rollers 86 receive the sheet P1 at the home position and continue transporting the sheet P1. At this time, the sorting rollers 86 forming the pair are naturally in a state of pressing against each other.

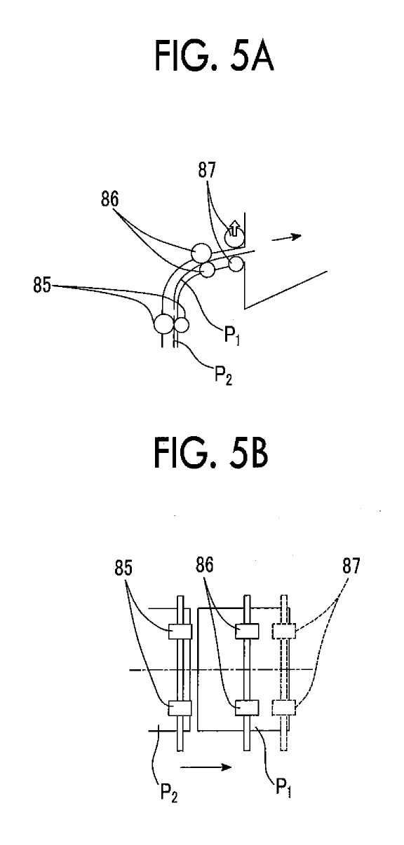

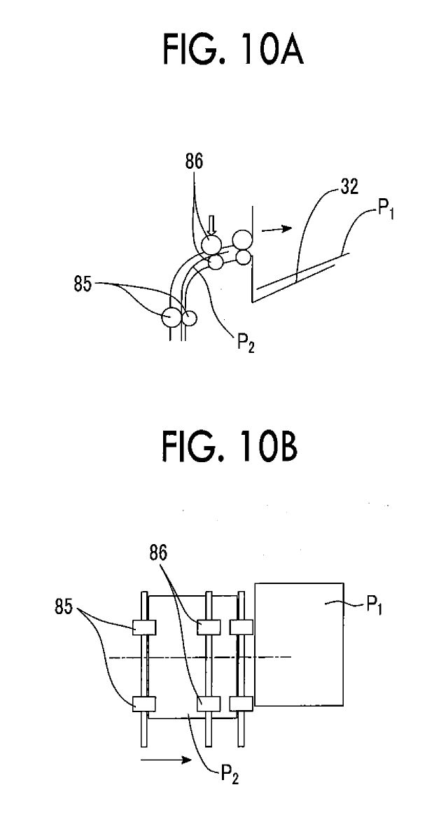

FIGS. 5A to 10B are diagrams illustrating the order of discharging sheets to the second discharge position. FIGS. 5A, 6A, 7A, 8A, 9A, and 10A illustrate side views, and FIGS. 5B, 6B, 7B, 8B, 9B, and 10B illustrate plan views.

When the sheet P1 reaches the position of the discharge rollers 87, as illustrated in FIG. 5A, the pair of discharge rollers 87 are moved in the direction in which they become separated from each other by the second contact and separation motor 88_2 (here, as an example, one of the pair is moved upward in FIG. 5A). As a result, the transportation of the sheet P1 is continued by the sorting rollers 86, and the discharge rollers 87 do not contribute to the transportation and do not interrupt the movement of the sheet 91. In FIG. 5B, the discharge rollers 87 are illustrated by the dotted lines to represent that the pair of discharge rollers 87 are separated from each other.

As illustrated in FIG. 5A, a subsequent sheet P2 reaches the transporting rollers 85 immediately after the trailing edge of the sheet P1 leaves.

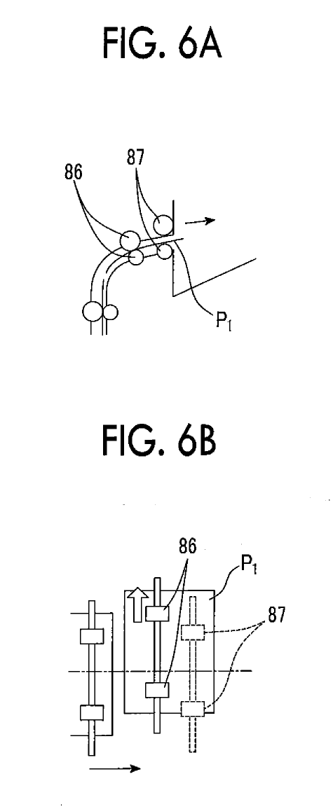

Next, as illustrated in FIGS. 6A and 6B, the sorting rollers 86 are moved to the shift position by the moving motor 89 while continuing transporting the sheet P1. As a result, the sheet P1 moves to the second discharge position. At this time, as illustrated in FIG. 6A, the sheet P1 is positioned between the discharge rollers 87. However, as described above, since the pair of the discharge rollers 87 are separated from each other, the movement of the sheet P1 including both the movement in the transport direction and the movement to the second discharge position is not restrained.

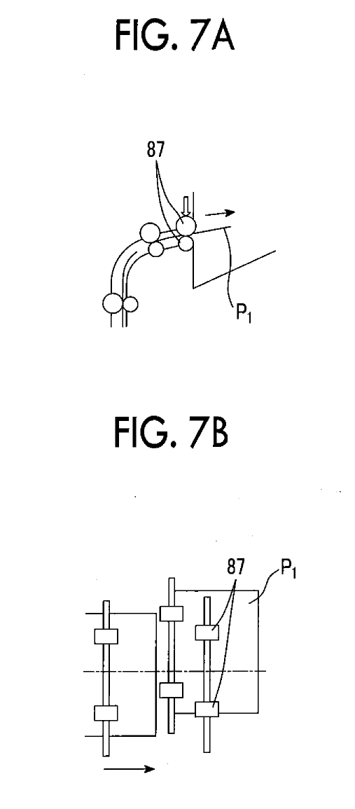

Next, as illustrated in FIGS. 7A and 7B, the pair of discharge rollers 87 are moved to the position at which they are pressed against each other, by the second contact and separation motor 88_2 such that the sheet P1 is nipped between the pair of the discharge rollers 87. As a result, the sheet P1 is transported by both the sorting rollers 86 and the discharge rollers 87.

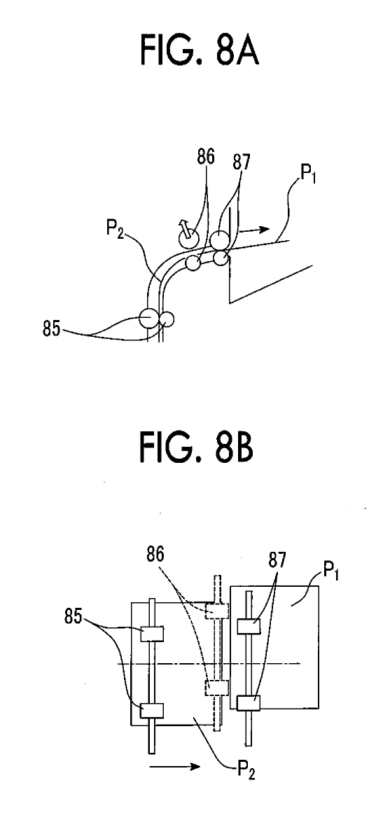

Thereafter, when the transportation of the sheet P1 proceeds, as illustrated in FIGS. 8A and 8B, the pair of sorting rollers 86 are moved to the position at which they are separated from each other (here, as an example, one of the pair is moved upward in FIG. 8A), by the first contact and separation motor 88_1 before the subsequent sheet P2 reaches. In FIG. 8B, the sorting rollers 86 are illustrated by the dotted lines to represent that the pair of sorting rollers 86 are separated from each other. As a result, the transportation of the subsequent sheet P2 is continued by the transporting rollers 85, and the transportation of the initial sheet P1 is continued by the discharge rollers 87.

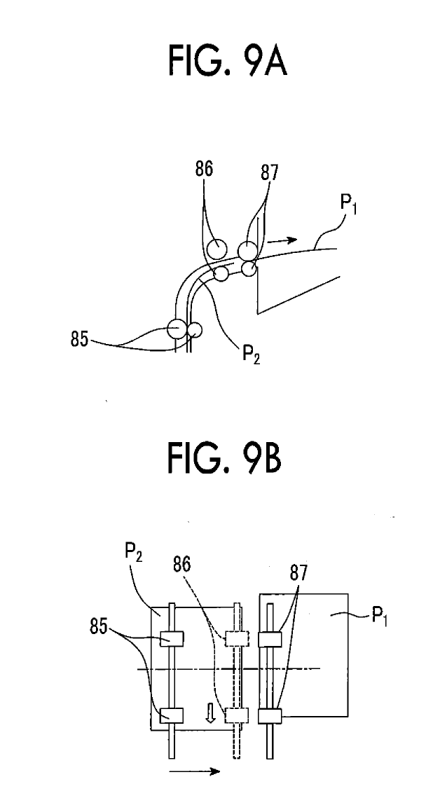

Next, as illustrated in FIG. 9B, the sorting rollers 86 are returned to the home position by the moving motor 89. At this time, as illustrated in FIG. 9A, the subsequent sheet P2 reaches a position between the sorting rollers 86. However, since the pair of sorting rollers 86 are separated from each other, the movement of the sorting rollers 86 does not interrupt the transportation of the subsequent sheet P2.

When the transportation further proceeds, the initial sheet P1 is stacked on the sheet discharge tray 32 by the discharge rollers 87, and the pair of sorting rollers 86 are moved to a position at which they are pressed against each other by the first contact and separation motor 88_1 before the trailing edge of the subsequent sheet P2 reaches the transporting rollers 85. As a result, the subsequent sheet P2 is continuously transported by both the transporting rollers 85 and the sorting rollers 86.

Thereafter, returning to the state illustrated in FIGS. 4A and 4B, the above-described order is repeated.

Timing in the above-described order will now be described.

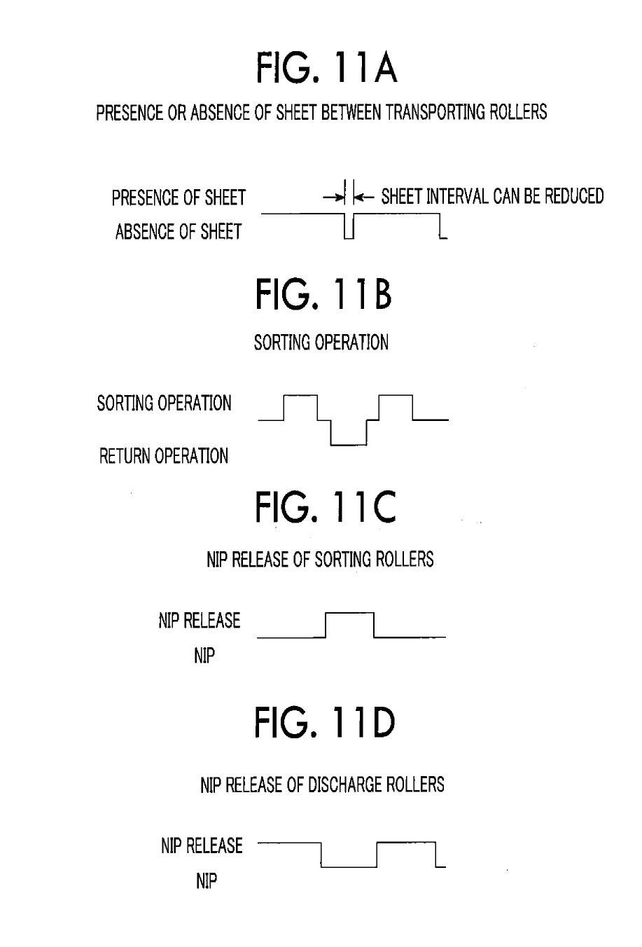

FIGS. 11A to 11D are timing charts illustrating the operational timing of each unit in the order illustrated in FIGS. 4A to 10B.

In FIG. 11A, timing in which a sheet passes through the transporting rollers 85 is illustrated, and the vertical axis of the chart of FIG. 11A represents the presence or absence of the sheet between the transporting rollers 85 forming the pair.

In FIG. 11B, movement timing of the sorting rollers 86 is illustrated. The vertical axis of the chart of FIG. 11B represents the movement direction of the sorting rollers 86. The sorting rollers 86 are moved to the shift position side during the “sorting operation” and the sorting rollers 86 are moved to the home position side during the “return operation”.

In FIG. 11C, timing in which the pair of sorting rollers 86 are pressed against each other (nipped) and are separated from each other (released) is illustrated. In FIG. 11D, timing in which the pair of discharge rollers 87 are nipped against each other and are released from each other is illustrated. The vertical axes of FIGS. 11C and 11D represent “nip” and “nip release” (that is, release).

As it may be seen by comparing the charts of FIGS. 11B and 11C to each other, the pair of sorting rollers 86 are separated from each other while the sorting rollers 86 are moved to return from the shift position to the home position. Accordingly, the transportation of the sheet is continued during the return operation of the sorting rollers 86. Therefore, as it may be seen by comparing the charts of FIGS. 11A and 11B to each other, the time interval between sheets transported by the transporting rollers 85 is shorter than a time needed for the sorting rollers 86 to perform the return operation, resulting in an increase in productivity during image formation.

In addition, as it may be seen by comparing the charts of FIGS. 11B and 11D to each other, the pair of discharge rollers 87 are separated from each other while the sorting rollers 86 are moved to the shift position from the home position. Accordingly, the discharge rollers 87 do not interrupt the movement of the sheets. Furthermore, as it may be seen by comparing the charts of FIGS. 11C and 11D to each other, the discharge rollers 87 are pressed against each other while the sorting rollers 86 are separated from each other, and thus the transportation of the sheets is stably continued.

The description of this exemplary embodiment is ended.

In addition, in the description of the exemplary embodiment, as an example of the image forming apparatus of the invention, the multifunction machine is presented. However, the image forming apparatus of the invention may be a single-function device such as each of a printer, a copying machine, and a facsimile.

In addition, in the description of the exemplary embodiment, as an example of the image forming device described in the invention, a so-called tandem-type color machine is presented. However, the image forming device described in the invention may also be a so-called revolver-type color machine or a monochrome machine.

In addition, in the description of the exemplary embodiment, an example in which the pair of second rotating members and the second pressing and separating unit described in the invention are provided is presented. However, the image forming apparatus of the invention does not necessarily include the pair of second rotating members and the second pressing and separating unit. The transportation of sheets becomes more stable when the pair of second rotating members and the second pressing and separating unit are included. However, although the pair of second rotating members and the second pressing and separating unit are not included, the productivity during image formation is enhanced. In this case, the sheet discharge tray 32 is positioned at the immediately rear of the sorting rollers 86 in the transport direction illustrated in FIGS. 4A and 4B.

In addition, in the description of the exemplary embodiment, an example in which, as the first pressing and separating unit and the second pressing and separating unit, one of the rotating members forming a pair is moved is presented. However, as the first pressing and separating unit and the second pressing and separating unit described in the invention, both the rotating members forming the pair may be moved.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image forming device that forms an image on a recording medium;
a stacking table on which the recording medium having the image formed thereon by the image forming device is stacked; and
a medium transporting device that transports the recording medium to the stacking table from the image forming device,
wherein the medium transporting device includes:
a pair of rotating members that feed the recording medium to the stacking table by nipping the recording medium therebetween and rotating;
a moving unit that allows the pair of rotating members to reciprocate in a direction along a rotating shaft of the pair of rotating members; and
a pressing and separating unit that allows the pair of rotating members to be pressed against each other in a forward path during the reciprocation by the moving unit and to be separated from each other in a return path during the reciprocation by the moving unit.

2. The image forming apparatus according to claim 1,
wherein the medium transporting device includes a pair of first rotating members and a first pressing and separating unit as the pair of rotating members and the pressing and separating unit, and
the medium transporting device further includes:
a pair of second rotating members that are arranged in parallel to the pair of first rotating members and feed the recording medium to the stacking table by nipping the recording medium therebetween and rotating; and
a second pressing and separating unit that allows the pair of second rotating members to be separated from each other in the forward path during the reciprocation of the pair of first rotating members and to be separated from each other in the return path.

3. A medium transporting device comprising:
a pair of rotating members that feed a medium by nipping the medium therebetween and rotating;
a moving unit that allows the pair of rotating members to reciprocate in a direction along a rotating shaft of the pair of rotating members; and
a pressing and separating unit that allows the pair of rotating members to be pressed against each other in a forward path during the reciprocation by the moving unit and to be separated from each other in a return path during the reciprocation by the moving unit.

4. The image forming apparatus according to claim 1 is a multifunction machine, or a single-function device.

5. The image forming apparatus according to claim 1,
wherein the image forming device is a tandem-type color machine, a revolver-type color machine, or a monochrome machine.
